(19) United States
(12) Patent Application Publication
(10) Pub. No.: US 2010/0013830 A1
(43) Pub. Date: Jan. 21, 2010

(54) Processing Of Signals From Global Navigation Satellite Systems By A Graphics Processor

(76) Inventors: Mats Robin Hakanson, Vetlanda (SE); Alexander Mitelman, Stockholm (SE); Christian Stahlberg, Sollentuna (SE)

Correspondence Address: DLA PIPER LLP (US ), 2000 UNIVERSITY AVENUE, EAST PALO ALTO, CA, 94303-2248, US

(21) Appl. No.: 12/376,115

(22) PCT Filed: Sep. 8, 2006
(86) PCT No.: PCT/US06/34924

§ 371 Date: Sep. 30, 2009

(51) Int. Cl. G06T 15/00; G01S 1/00

(52) U.S. Cl. 345/419; 342/357.12

(57) ABSTRACT

The programmable graphics processor processing a signal from a global navigation satellite system (“GNSS”); has a rasterizer unit, a pixel shader unit and a memory unit. GNSS satellite, received signal converted into a digitized form of the received signal, and transformed by a programmable graphics processor, wherein an array of a corresponding data of the digitized form signal is stored in the memory unit and operated by the pixel shader unit forming a resulting array, written into the memory unit at the first address (see FIG. 3). A first address and values of the endpoints of the array of the corresponding data of the digitized form signal are supplied to the rasterizer unit. The rasterizer unit interpolates values between values of endpoints of the array. The values of the endpoints and the interpolated values of the array correspond to addresses in the memory unit for the array of the corresponding data of the digitized form signal.

### TECHNICAL FIELD

The present invention relates to a method for processing signals from a global navigation satellite system (“GNSS”), such as the Global Positioning System (GPS), the Galileo System, or the GLONASS system, and more particularly to a method for processing such signals by the use of a conventional graphics processor. The present invention also relates to an article of manufacture comprising computer readable program code configured to process the signals from such a satellite navigation system.

### BACKGROUND OF THE INVENTION

GNSS is well known in the art. Presently, GPS is fully operational and GLONASS is functional but in some disarray; the Galileo System is beginning to be deployed. The present invention can be used with all types of GNSS, although for the purpose of explanation of the present invention, reference will be made to GPS.

FIG. 1 shows a schematic diagram of GPS to which the method of the present invention can be applied. The space segment of GPS consists of a plurality of satellites (24), with another set of operational spare satellites (such as 6), for a total of thirty (30) satellites in orbit. Each satellite orbits the earth at an approximate altitude of 20,160 km and repeats its ground track over any particular point on earth approximately twice per sidereal day (23 hours, 56 minutes, 4 seconds). The satellites are arranged in 6 orbital planes inclined at approximately 55 degrees with respect to the equator and are evenly spaced around the equator.

For GPS applications, at any location on earth, the signals from four (4) different satellites can uniquely determine the position/time at the received location. The system is designed so that all satellites nominally transmit at the same time and on the same carrier frequency (1575.42 MHz). Multiple access, which is the ability to receive an individual satellite's signal in the presence of other signals on the same frequency, is accomplished by means of a unique repeating modulation, or “spreading code,” assigned to each satellite. This modulation enables the receiver to selectively decode the navigation data from a particular satellite, and serves as a unique identifier. Because each satellite is orbiting the earth and is moving relative to the receiver's location, the signal received from that satellite at that location and time will have a specific Doppler shift frequency with respect to the nominal carrier frequency. From the knowledge of the Doppler shift and the timing of the modulation code repetitions, or “code phase,” for each received satellite signal, the position/time at the particular location on earth can be determined using the principle of triangulation.

The mathematics of processing the signal(s) from the GNSS satellites is well known in the art. In general, the signal from each satellite must first be acquired, and once acquired, it must be tracked. For acquisition, the frequency spectrum is searched over many Doppler values, which are applied to locally stored replicas of the expected satellite signal. Thus, for example, a number of replicas are generated with frequency shifts of up to ±5 KHz from the expected frequency for each satellite. Each replica is characterized by its associated frequency shift. A frequency domain correlation operation is then performed between the received signal and an array of replica signals having the various Doppler shifted values. From this frequency domain correlation operation, a maximal value is determined and compared against a threshold. The location of a unique maximum that exceeds the threshold identifies both the Doppler frequency and the timing of the code modulation for a particular satellite signal. From this calculation, the information relative to Doppler shift and time delay is used to track the satellite so identified. Typically, this is used to adjust the tracking loops in the receiver, e.g. a phase lock loop and a delay lock loop. While in principle this calculation appears to be simple, the actual implementation is quite computationally intensive. Considerations for a practical GPS receiver must include not only cost, but also rapidity of the calculation, and in most cases power (usually battery) consumption, since these receivers are often intended to be used in portable devices.

One prior art processor is called a programmable graphics processor, such as those available from Nvidia Corporation of Santa Clara, Calif. A programmable graphics processor, as will be discussed in greater detail hereinafter, is characterized by a rasterizer unit, a texture unit, a pixel shader unit, and a frame buffer unit. The texture unit and the frame buffer unit are simply memory locations where data are stored. The rasterizer unit receives data indicating values of endpoints of an array in the texture unit and performs an interpolation between the endpoint values, and sends the result to the pixel shader unit. The pixel shader unit operates on the data read from the texture unit and stores the result in the frame buffer unit for ultimate display on a display unit such as an LCD display. The pixel shader unit is the programmable portion of the programmable graphics processor.

It is one aim of the present invention to provide a method of rapidly processing signals from a GNSS using the elements of a graphics processor.

### SUMMARY OF THE INVENTION

In the present invention, a method of processing a signal from a navigation satellite first receives the signal from the navigation satellite and forms a received signal. The received signal is converted into a digitized form signal. The digitized form signal is transformed by a programmable graphics processor having a rasterizer unit, a pixel shader unit and a memory unit. A first array of a first corresponding data of the digitized form signal are stored in the memory unit. The first addresses and values of endpoints of the first array of the first corresponding data of the digitized form signal are supplied to the rasterizer unit. The rasterizer unit generates a plurality of interpolated values between values of endpoints of the first array. The plurality of interpolated values and values of endpoints for the first array correspond to addresses in the memory unit for the first array of first corresponding data of the digitized form signal. The pixel shader unit operates on the first array of first corresponding data of the digitized signal from the memory unit, based upon the plurality of interpolated values and values of the endpoints for the first array supplied from the rasterizer unit to form a resulting array of corresponding data. The resulting array is stored in the memory unit, at the first addresses.

### BRIEF DESCRIPTION OF THE DRAWINGS

FIG. 1 is a schematic diagram of GPS.

FIG. 2 is a schematic block diagram of an apparatus suitable for carrying out the method of the present invention, and for executing the computer readable program code of the present invention.

FIG. 3 is a detailed block level diagram of a portion of a programmable graphics processor for carrying out the method of the present invention.

FIG. 4 is a chart showing the determination of the particular Doppler value and time shift used to acquire and track a GNSS satellite.

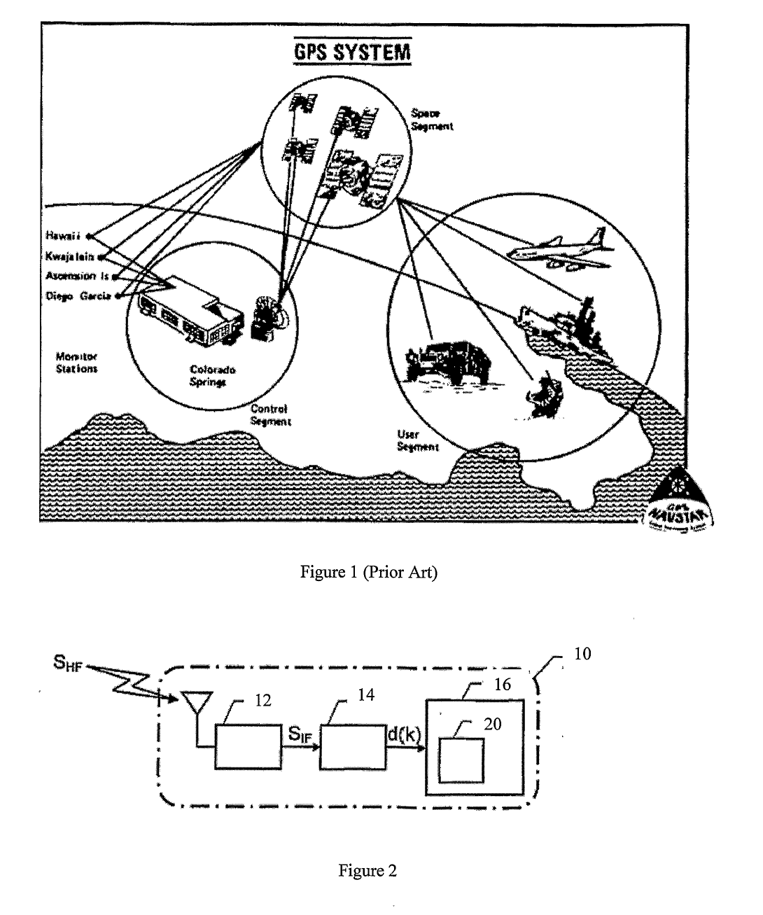

### DETAILED DESCRIPTION OF THE INVENTION

FIG. 2 shows a block level schematic diagram of an apparatus 10 suitable for carrying out the method of the present invention. The apparatus 10 is a receiver for receiving signals generated from one or more GNSS satellites. As previously discussed, for the purpose of explanation of the present invention, the discussion set forth herein is focused on GPS, although the present invention may be used in the processing of a signal from any GNSS satellite.

The apparatus 10 comprises an antenna for receiving a signal from a GPS satellite. The signal, Shf, (Signal High Frequency) is received by the apparatus 10 and is processed through a conventional analog processing circuit 12, which includes circuits such as a low noise amplifier (LNA) and a frequency down converter circuit, to generate an analog processed signal, Sif (Signal Intermediate Frequency). The signal Sif is supplied to a second processing circuit 14 which may include further down conversion of the frequency Sif, and is then digitized to form a digitized form signal d(k) of the received signal Shf. Finally, the digitized form signal d(k) is supplied to a digital processing circuit 16, which may include one or more digital processors, such as DSP, microprocessor, state machine, and/or hardwired logic circuits. In the context of the present invention, the digital processing circuit 16 also includes a programmable graphics processor 20. Since all of the GNSS satellites operate at the same frequency, the apparatus 10 receives signals from all of the satellites (that are in view of the GPS receiver apparatus 10, or are received by the apparatus 10) and processes them in parallel.

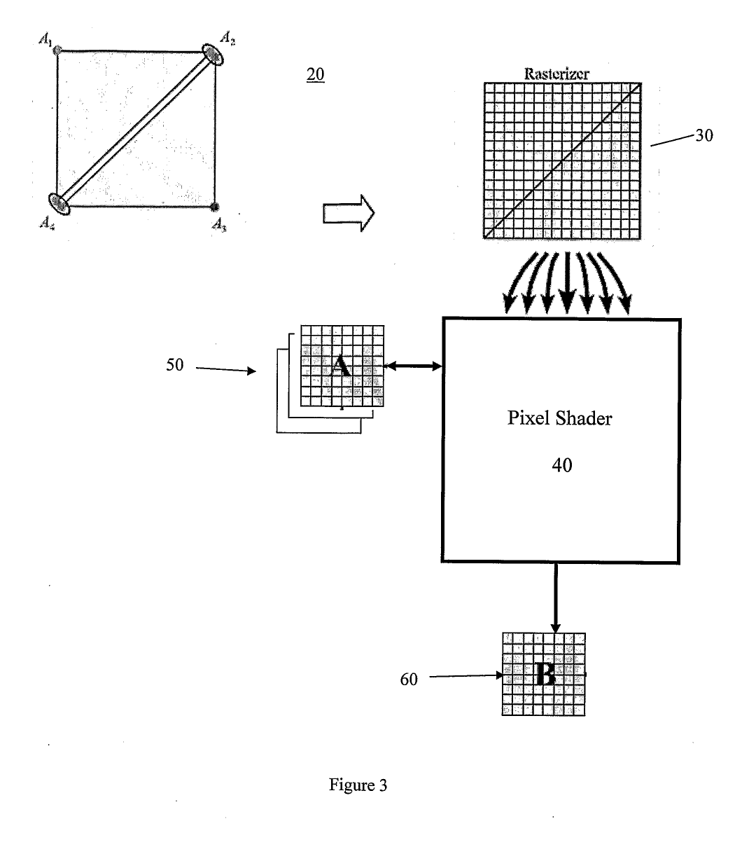

FIG. 3 shows a block level diagram of a programmable graphics processor 20 useful for carrying out the method of the present invention. The programmable graphics processor 20 is a conventional well known programmable graphics processor, such as that from Nvidia Corporation of Santa Clara, Calif. The programmable graphics processor 20 typically in the prior art has been used to take data and render the data for display on a display device, such as an LCD display, or to perform other image processing tasks for later display, such as medical diagnostic imaging. Thus, although they are processors, in the sense that they are capable of performing logic comparison of data, and manipulation thereof, programmable graphics processors of this type have typically been used for the special purpose of creating realistic displays on a display device.

The programmable graphics processor 20 shown in FIG. 3 is useful for carrying out the method of the present invention, and comprises a rasterizer unit 30, a pixel shader unit 40, one or more texture units 50, and a frame buffer unit 60. The texture units 50 and the frame buffer unit 60 are logically separate memory units, but physically they may comprise a single memory unit. In the prior art, the rasterizer unit 30 when supplied with values at endpoints of an array can perform an interpolation of the values in between the values of the endpoints of the array. Further, in the prior art, the pixel shader unit 40 is the programmable portion of the programmable graphics processor 20. The pixel shader unit 40 can read data from the texture units 50 and output the resultant data into the frame buffer unit 60. From the frame buffer unit 60, the data is typically displayed on a display device (not shown).

In the method of the present invention, the programmable graphics processor 20 receives values of endpoints of an array. Thus, as shown in FIG. 3, the values of the endpoint of an array received by the processor 20 may have the values (A1, A2, A3 and A4). Each value A1, A2, A3 or A4 may contain a set of values. Associated with each value which are the endpoints of the array are addresses. Thus, although not shown in FIG. 3, an address of (x1, y1) would be associated with the value A1, an, address of (x2, y2) would be associate with the value A2, an address of (x3, y3) would be associate with the value A3, and an address of (x4, y4) would be associate with the value A4.

The rasterizer unit 30 receives the inputted information (x1, y1), A1; (x2, y2), A2; (x3, y3), A3; and (x4, y4), A4, and operates on them by performing an interpolation of all the values between all of the endpoints A1, A2, A3 and A4. In essence, the rasterizer unit 30 performs an interpolation of all the values in the array bounded by the endpoint values of A1, A2, A3 and A4. The endpoint values A1, A2, A3, and A4, along with the interpolated values therebetween, are passed to the pixel shader unit 40. The pixel shader unit 40 reads the array of data from the texture memory unit 50 at the addresses defined by A1, A2, A3, A4 and all the values interpolated therebetween. An array of data is previously stored in the texture memory unit 50 at the location of A1, A2, A3 and A4.

The pixel shader unit 40 operates on the array of data from the texture memory unit 50 at the address location of A1, A2, A3 and A4, and then stores the result in the frame buffer memory unit 60 at the address location defined by (x1, y1); (x2, y2); (x3, y3); and (x4, y4).

In a preferred embodiment, because the programmable graphics processor 20 is particularly adapted to process data in the form of a triangle, the array of data whose endpoint values are defined by A1, A2, A3 and A4, are the endpoints of two triangles adjacent to one another.

One of the processes that the programmable graphics processor 20 can perform is a Fast Fourier Transform (FFT) or an inverse FFT of an array. An FFT operation or an inverse FFT operation is one of the operations commonly used in the processing of a signal from a GNSS satellite to determine the position/time of a location by a receiver. Thus, for example, in an FFT operation, the untransformed array of data is stored in the texture memory unit 50 at the address locations defined by the values of endpoints A1, A2, A3, A4, and the values therebetween interpolated by the rasterizer unit 30. The pixel shader unit 40 operates on the array of data read from the texture memory unit 50 to form an FFT transform thereof and store the results at the addresses (x1, y1); (x2, y2); (x3, y3); and (x4, y4) in the frame buffer memory unit 60. Typically, in an FFT (or inverse FFT) operation, as is well known in the art, many process steps are required. Thus, after the results are stored in the frame buffer memory unit 60, the results are then copied to the texture memory unit 50 at the address location defined by the endpoint values of the array A1, A2, A3, and A4. The programmable graphics processor 20 is then re-initiated. This iterative process continues until the FFT (or inverse FFT) operation is completed. The programming of the pixel shader unit 40 to perform the FFT operation (or an inverse FFT operation) is well known to those in the art.

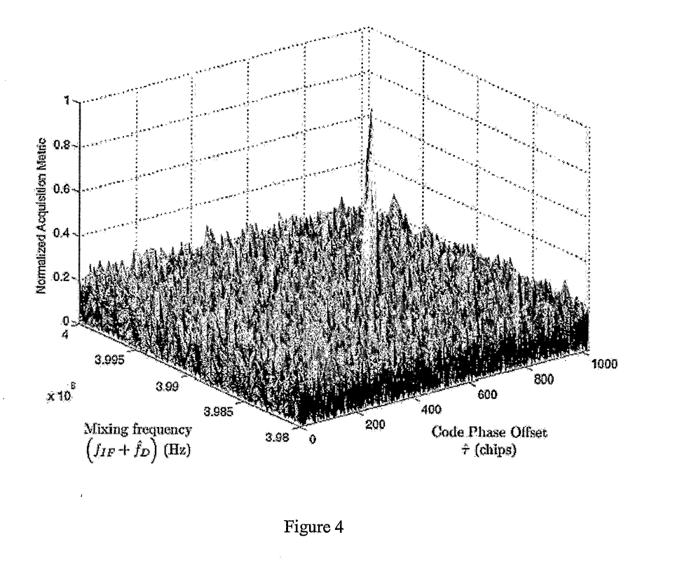

Another process that the programmable graphics processor 20 can perform is a frequency domain correlation operation between two arrays of data: one array is the array of data received from the GNSS satellites, while another array of data is one of the local replicas having Doppler shifted values. The operation of frequency domain correlation operation between two arrays of data by the programmable graphics processor 20 includes forming an FFT (or an inverse FFT) operation on an array of data. The two arrays of data, (defined by the values of the endpoints A1, A2, A3, and A4, and by the endpoints B1, B2, B3, and B4) are stored in the texture memory unit 50 at locations defined by the values of endpoints A1, A2, A3, A4, and the values therebetween interpolated by the rasterizer unit 30, and by the values of endpoints B1, B2, B3, B4, and the values therebetween interpolated by the rasterizer unit 30. The two arrays of data are read from the texture memory unit 50 by the pixel shader unit 40, and operated thereon to form a frequency domain correlation thereof. The result is a single array, a collection of which comprises a three-dimensional figure, such as that depicted in FIG. 4. This result is stored in the frame buffer memory 60. Again, similar to the discussion heretofore, with regard to the FFT (or inverse FFT) operation, a frequency domain correlation operation may require a multi-step process. Thus, after the results are stored in the frame buffer memory 60, they are copied back into the texture memory unit 50, and the programmable graphics processor 20 is re-initiated. The process is iteratively performed until the frequency domain correlation operation is completed.

The frequency domain correlation operation operates between a signal received from one or more GNSS satellites and a locally generated replica signal of a particular satellite. If there is a correlation between the two arrays as a result of the frequency domain correlation operation, then there is a maximal value as shown in FIG. 4. In the graph shown in FIG. 4, one of the axes is the Doppler shift value and the other is a time phase shift value. If a maximal value is found, then the Doppler shift and the time shift corresponding to the maximal value are then used to lock onto that satellite. Thus, for example, the Doppler value and the time shift value may be used by a phase or delay lock loop to lock onto the satellite, as is well known to those skilled in the art.

Once the signal from a satellite is acquired, the satellite must be tracked as it traverses its orbit. One method to track a satellite is to generate time shifted correlator samples, one on either side of the time shift value of the code phase estimate used for tracking the satellite, and typically equally spaced from the code phase estimate. The time shifted correlator samples are then compared to one another and the time shift value is adjusted based upon the comparing step, such that the time shifted correlator samples remain equal to one another.

The use of a programmable graphics processor 20 to perform operations such as FFT transforms or inverse transforms on a single array of data or a frequency domain correlation on two arrays of data is advantageous because such programmable processors 20 are adapted to perform calculations in parallel, rapidly, thereby saving time. In addition, many GPS receivers 10 are part of an apparatus containing processors that perform other functions, such as cellular phone, PDA, digital camera, etc. This apparatus may have a programmable graphics processor 20 that is otherwise idling while the GPS receiver 10 is performing the functions of acquiring and tracking signals from various GPS satellites. Thus, the present invention more efficiently utilizes all of the resources of a portable electronic device in acquiring and tracking a GPS signal.

What is claimed is:

1. A method of processing a signal from a navigation satellite comprising:
receiving a signal from said navigation satellite to form a received signal;
converting said received signal into a digitized form signal;
transforming said digitized form signal by a programmable graphics processor having a rasterizer unit, a pixel shader unit and a memory unit, wherein a first array of a first corresponding data of said digitized form signal are stored in said memory unit, and wherein said transforming step further comprising:
supplying first addresses and values of endpoints of said first array of said first corresponding data of said digitized form signal to said rasterizer unit;
generating a plurality of interpolated values between values of endpoints of said first array, by said rasterizer unit, wherein said plurality of interpolated values and values of endpoints for said first array corresponds to addresses in said memory unit for said first array of first corresponding data of said digitized form signal;
operating on said first array of first corresponding data of said digitized signal from the memory unit by said pixel shader unit based upon said plurality of interpolated values and values of said endpoints for said first array supplied from said rasterizer unit to form a resulting array of corresponding data; and
storing said resulting array in said memory unit, at said first addresses.

2. The method of claim 1 wherein a second array of a second corresponding data of said digitized form signal are stored in said memory unit, and wherein said transforming step further comprising:
supplying second addresses and values of endpoints of said second array of said second corresponding data of said digitized form signal to said rasterizer unit;
generating a plurality of interpolated values between values of endpoints of said second array, by said rasterizer unit, wherein said plurality of interpolated values and values of endpoints for said second array corresponds to addresses in said memory unit for said second array of second corresponding data of said digitized form signal;
operating on said first array and second array of first and second corresponding data of said digitized signal from the memory unit by said pixel shader unit based upon said plurality of interpolated values and values of said endpoints for said first and second array supplied from said rasterizer unit to form a resulting array of corresponding data; and
storing said resulting array in said memory unit, at said second addresses.

3. The method of claim 2 wherein said second addresses are the same as the first addresses.

4. The method of claim 3 or 1 wherein said first addresses comprise endpoints of a triangle.

5. The method of claim 3 wherein said first corresponding data of said digitized form signal corresponds to said received signal and has a characteristic Doppler shift with respect to a nominal frequency.

6. The method of claim 5 wherein said second corresponding data of said digitized form signal is a pre-computed replica signal of said digitized form signal.

7. The method of claim 6 wherein said processing is performed for a plurality of navigation satellites to receive a plurality of signals from said plurality of satellites, determining the position/time related data based upon said plurality of signals received.

8. The method of claim 7 wherein said pre-computed replica signal has a characteristic Doppler frequency, and a plurality of samples.

9. The method of claim 8 wherein said method acquires a plurality of signals from a plurality of navigation satellites and
wherein said second array of second corresponding data for said digitized form signal comprises a plurality of frequency shifted signals, each frequency shifted signal shifted in frequency by a characteristic Doppler value.

10. The method of acquiring a plurality of signals from a plurality of navigation satellite of claim 9 wherein said method comprises:
performing a frequency domain correlation operation between said first array of digitized form signals and said second array of digitized form signals to form an array of correlation functions.

11. The method of acquiring a plurality of signals from a plurality of navigation satellite of claim 10, further comprising:
determining a maximal value, if one exists, for each received signal.

12. The method of acquiring a plurality of signals from a plurality of navigation satellites of claim 11 wherein in the event a maximal value is determined, the associated characteristic Doppler shift and associated code phase value of the frequency shifted signal of the first array corresponding to the maximal value in the array of correlation functions is used to lock onto the received signal.

13. The method of claim 11 wherein said processing a signal from a navigation satellite comprises a method of tracking each of said plurality of satellites.

14. The method of claim 12 wherein said method of tracking further comprising:
generating a plurality of time shifted correlator samples, time shifted on either side of said code phase value, associated with said maximal value, at said frequency shift associated with said maximal value;
comparing said plurality of time shifted correlator samples;
adjusting said time shift based on said comparing step.

15. An article of manufacturing for processing a signal from a navigation satellite, wherein the signal is received and is converted into a digitized form signal, and is further transformed by a programmable graphics processor having a rasterizer unit, a pixel shader unit and a memory unit, wherein a first array of a first corresponding data of said digitized form signal are stored in said memory unit, wherein said article of manufacturing comprising:
computer usable medium having computer readable program code embedded therein, wherein said computer usable medium further comprises:
computer readable program code configured to cause the programmable graphics processor to received first addresses and values of endpoints of the first array of first corresponding data of said digitized form signal to said rasterizer unit;
computer readable program code configured to cause the programmable graphics processor to generate a plurality of interpolated values between values of said endpoints of said first array by said rasterizer unit, wherein said plurality of interpolated values and values of said endpoints for said first array corresponds to addresses in said memory unit for said first array of first corresponding data of said digitized form signal;
computer readable program code configured to cause the programmable graphics processor to operate on said first array of first corresponding data of said digitized form signal from the memory unit by said pixel shader unit based upon said plurality of interpolated values and values of said endpoints for said first array supplied from said rasterizer unit, to form a resulting array of corresponding data; and
computer readable program code configured to cause the programmable graphics processor to store the resulting array in said memory unit at said first addresses.

16. The article of manufacturing of claim 15 wherein said first addresses comprise endpoints of a triangle.

17. The article of manufacturing of claim 15 wherein a second array of a second corresponding data of said digitized form signal are stored in said memory unit, and wherein said computer usable medium further comprises:
computer readable program code configured to cause the programmable graphics processor to received second addresses and values of endpoints of the second array of second corresponding data of said digitized form signal to said rasterizer unit;
computer readable program code configured to cause the programmable graphics processor to generate a plurality of interpolated values between values of said endpoints of said second array by said rasterizer unit, wherein said plurality of interpolated values and values of said endpoints for said second array corresponds to addresses in said memory unit for said second array of first corresponding data of said digitized form signal;
computer readable program code configured to cause the programmable graphics processor to operate on said second array of first corresponding data of said digitized form signal from the memory unit by said pixel shader unit based upon said plurality of interpolated values and values of said endpoints for said second array supplied from said rasterizer unit, to form a resulting array of corresponding data; and
computer readable program code configured to cause the programmable graphics processor to store the resulting array in said memory unit at said second addresses.

18. The article of manufacturing of claim 17,
wherein said first corresponding data of said digitized form signal corresponds to said received signal and has a characteristic Doppler shift with respect to a nominal frequency;
wherein said second corresponding data of said digitized form signal is a pre-computed replica signal of said digitized form signal, having a characteristic Doppler frequency and a plurality of samples; and
wherein said processing is performed for a plurality of navigation satellites to receive a plurality of signals from said plurality of navigation satellites to determine the position/time relates data based upon the plurality of signals received.

19. The article of manufacture of claim 18, wherein said second array of second corresponding data fro said digitized form signal comprises a plurality of frequency shifted signals, each frequency shifted signal shifted in frequency by a characteristic Doppler value.

20. The article of manufacture of claim 19 wherein said computer usable medium further comprises:
computer readable program code configured to cause the pixel shader unit to perform a frequency domain correlation operation between said first array of digitized form signal and said second array of digitized form signal to form an array of correlation functions.

21. The article of manufacture of claim 20 wherein said computer usable medium further comprises:
computer readable program code configured to determine a maximal value, if one exists, for each received signal.

22. The article of manufacture of claim 21 wherein said computer usable medium further comprises:
computer readable program code configured to lock onto the received signal, in the event a maximal value is determined and the associated characteristic Doppler shift and associated code phase shift value of the frequency shifted signal of the first array corresponding to the maximal value in the array of correlation functions is used.

23. The article of manufacture of claim 21, wherein said computer usable medium further comprises:
computer readable program code configured to generate a plurality of time shifted correlator samples, time shifted on either side of said code phase value, associated with said maximal value, at said frequency shift associated with said maximal value;
computer readable program code configured to compare said plurality of time shifted correlator samples to produce a compared result;
computer readable program code configured to adjust said time shift based on said compared result.
